(19) United States
(12) Patent Application Publication
(10) Pub. No.: US 2025/0048483 A1
(43) Pub. Date: Feb. 6, 2025

(54) PATH SWITCH FAILURE HANDLING

(71) Applicant: QUALCOMM Incorporated, San Diego, CA (US)

(72) Inventors: Peng CHENG, Beijing (CN); Karthika PALADUGU, Hyderabad (IN); Hong CHENG, Basking Ridge, NJ (US)

(21) Appl. No.: 18/717,214

(22) PCT Filed: Feb. 11, 2022
(86) PCT No.: PCT/CN2022/075984

§ 371 Date: Jun. 6, 2024

(51) Int. Cl. H04W 76/27; H04W 76/19; H04W 88/04

(52) U.S. Cl. CPC H04W 76/27; H04W 76/19; H04W 88/04

(57) ABSTRACT

Various aspects of the present disclosure generally relate to wireless communication. In some aspects, a remote user equipment (UE) may receive an identifier associated with a relay UE and an identifier associated with a serving cell of the relay UE for a path switch. The UE may receive a local identifier associated with the remote UE based at least in part on connecting with the relay UE over a sidelink interface. The UE may identify, based at least in part on receiving the local identifier, a path switch failure condition associated with the relay UE while the relay UE is in an idle state or an inactive state. Numerous other aspects are described.

### FIELD OF THE DISCLOSURE

Aspects of the present disclosure generally relate to wireless communication and to techniques and apparatuses for path switch failure handling.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Tenn Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a remote user equipment (UE). The method may include receiving an identifier associated with a relay UE and an identifier associated with a serving cell of the relay UE for a path switch. The method may include receiving a local identifier associated with the remote UE based at least in part on connecting with the relay UE over a sidelink interface. The method may include identifying, based at least in part on receiving the local identifier, a path switch failure condition associated with the relay UE while the relay UE is in an idle state or an inactive state.

Some aspects described herein relate to a method of wireless communication performed by a relay UE. The method may include receiving, from a remote UE via a default sidelink radio link control channel, an RRC configuration complete indication. The method may include transmitting, to a network node, a request to enter a connected state of the relay UE based at least in part on receiving the RRC configuration complete indication. The method may include transmitting, to the network node, based at least in part on being in the connected state of the relay UE, a sidelink UE information message that requests a local identifier associated with the remote UE. The method may include receiving, from the network node, an RRC configuration indication that includes the local identifier.

Some aspects described herein relate to an apparatus for wireless communication performed by a remote UE. The apparatus may include a memory and one or more processors, coupled to the memory. The one or more processors may be configured to receive an identifier associated with a relay UE and an identifier associated with a serving cell of the relay UE for a path switch. The one or more processors may be configured to receive a local identifier associated with the remote UE based at least in part on connecting with the relay UE over a sidelink interface. The one or more processors may be configured to identify, based at least in part on receiving the local identifier, a path switch failure condition associated with the relay UE while the relay UE is in an idle state or an inactive state.

Some aspects described herein relate to an apparatus for wireless communication performed by a relay UE. The apparatus may include a memory and one or more processors, coupled to the memory. The one or more processors may be configured to receive, from a remote UE via a default sidelink radio link control channel, an RRC configuration complete indication. The one or more processors may be configured to transmit, to a network node, a request to enter a connected state of the relay UE based at least in part on receiving the RRC configuration complete indication. The one or more processors may be configured to transmit, to the network node, based at least in part on being in the connected state of the relay UE, a sidelink UE information message that requests a local identifier associated with the remote UE. The one or more processors may be configured to receive, from the network node, an RRC configuration indication that includes the local identifier.

Some aspects described herein relate to a non-transitory computer-readable medium that stores a set of instructions for wireless communication by a remote UE. The set of instructions, when executed by one or more processors of the UE, may cause the UE to receive an identifier associated with a relay UE and an identifier associated with a serving cell of the relay UE for a path switch. The set of instructions, when executed by one or more processors of the UE, may cause the UE to receive a local identifier associated with the remote UE based at least in part on connecting with the relay UE over a sidelink interface. The set of instructions, when executed by one or more processors of the UE, may cause the UE to identify, based at least in part on receiving the local identifier, a path switch failure condition associated with the relay UE while the relay UE is in an idle state or an inactive state.

Some aspects described herein relate to a non-transitory computer-readable medium that stores a set of instructions for wireless communication by a relay UE. The set of instructions, when executed by one or more processors of the UE, may cause the UE to receive, from a remote UE via a default sidelink radio link control channel, an RRC configuration complete indication. The set of instructions, when executed by one or more processors of the UE, may cause the UE to transmit, to a network node, a request to enter a connected state of the relay UE based at least in part on receiving the RRC configuration complete indication. The set of instructions, when executed by one or more processors of the UE, may cause the UE to transmit, to the network node, based at least in part on being in the connected state of the relay UE, a sidelink UE information message that requests a local identifier associated with the remote UE. The set of instructions, when executed by one or more processors of the UE, may cause the UE to receive, from the network node, an RRC configuration indication that includes the local identifier.

Some aspects described herein relate to an apparatus for wireless communication. The apparatus may include means for receiving an identifier associated with a relay UE and an identifier associated with a serving cell of the relay UE for a path switch. The apparatus may include means for receiving a local identifier associated with the apparatus based at least in part on connecting with the relay UE over a sidelink interface. The apparatus may include means for identifying, based at least in part on receiving the local identifier, a path switch failure condition associated with the relay UE while the relay UE is in an idle state or an inactive state.

Some aspects described herein relate to an apparatus for wireless communication. The apparatus may include means for receiving, from a remote UE via a default sidelink radio link control channel, an RRC configuration complete indication. The apparatus may include means for transmitting, to a network node, a request to enter a connected state of the apparatus based at least in part on receiving the RRC configuration complete indication. The apparatus may include means for transmitting, to the network node, based at least in part on being in the connected state of the apparatus, a sidelink UE information message that requests a local identifier associated with the remote UE. The apparatus may include means for receiving, from the network node, an RRC configuration indication that includes the local identifier.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of a mobility procedure for Layer 2 relay, in accordance with the present disclosure.

FIG. 6 is a diagram illustrating an example of a protocol stack, in accordance with the present disclosure.

FIG. 7 is a diagram illustrating an example of radio link control bearer information, in accordance with the present disclosure.

FIG. 8 is a diagram illustrating a first example associated with path switch failure handling, in accordance with the present disclosure.

FIG. 9 is a diagram illustrating a second example associated with path switch failure handling, in accordance with the present disclosure.

FIG. 10 is a diagram illustrating an example associated with remote local identifier assignment in a path switch, in accordance with the present disclosure.

FIG. 11 is a diagram illustrating a first example process associated with path switch failure handling, in accordance with the present disclosure.

FIG. 12 is a diagram illustrating a second example process associated with path switch failure handling, in accordance with the present disclosure.

FIG. 13 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

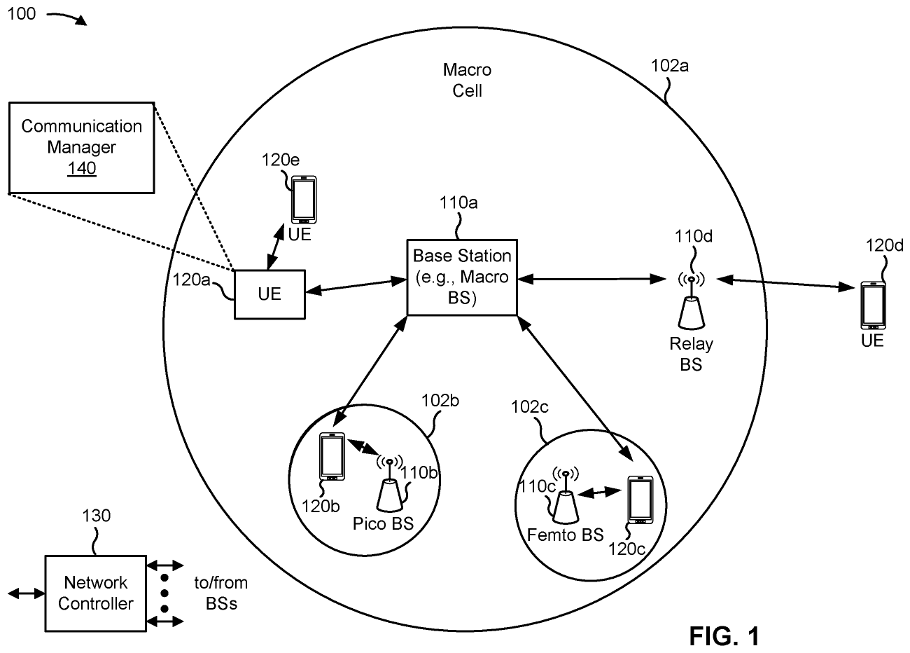

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some aspects, the term “base station” (e.g., the base station 110) or “network node” may refer to an aggregated base station, a disaggregated base station, an integrated access and backhaul (IAB) node, a relay node, and/or one or more components thereof. For example, in some aspects, “base station” or “network node” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the base station 110. In some aspects, the term “base station” or “network node” may refer to a plurality of devices configured to perform the one or more functions. For example, in some distributed systems, each of a number of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations and/or one or more virtual base station functions. For example, in some aspects, two or more base station functions may be instantiated on a single device. In some aspects, the term “base station” or “network node” may refer to one of the base station functions and not another. In this way, a single device may include more than one base station.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium. In some cases, the UE 120 may be a remote UE, such as the remote UE 505, or a relay UE, such as the relay UE 510, described herein.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the remote UE 505 may include a communication manager 140. As described in more detail elsewhere herein, the communication manager 140 may receive an identifier associated with a relay UE and an identifier associated with a serving cell of the relay UE for a path switch; receive a local identifier associated with the remote UE based at least in part on connecting with the relay UE over a sidelink interface; and identify, based at least in part on receiving the local identifier, a path switch failure condition associated with the relay UE while the relay UE is in an idle state or an inactive state. Additionally, or alternatively, the communication manager 140 may perform one or more other operations described herein.

In some aspects, the relay UE 510 may include the communication manager 140. As described in more detail elsewhere herein, the communication manager 140 may receive, from a remote UE via a default sidelink radio link control channel, a radio resource control (RRC) configuration complete indication; transmit, to a network node, a request to enter a connected state of the relay UE based at least in part on receiving the RRC configuration complete indication; transmit, to the network node, based at least in part on being in the connected state of the relay UE, a sidelink UE information message that requests a local identifier associated with the remote UE; and receive, from the network node, an RRC configuration indication that includes the local identifier. Additionally, or alternatively, the communication manager 140 may perform one or more other operations described herein.

As indicated above, FIG. 1 is provided as an example. Other examples may differ from what is described with regard to FIG. 1.

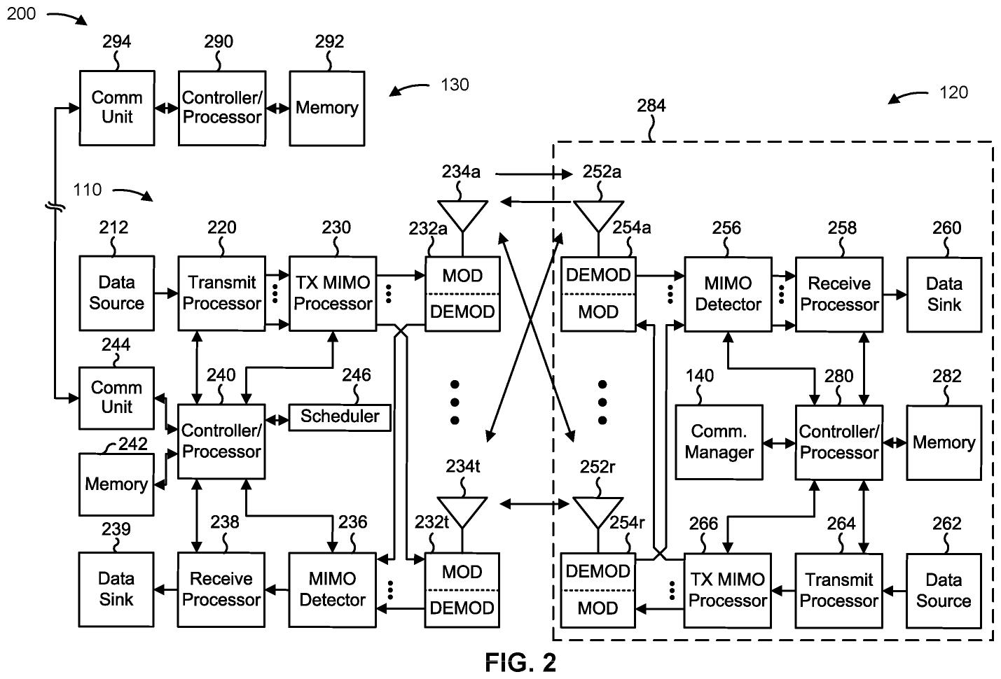

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

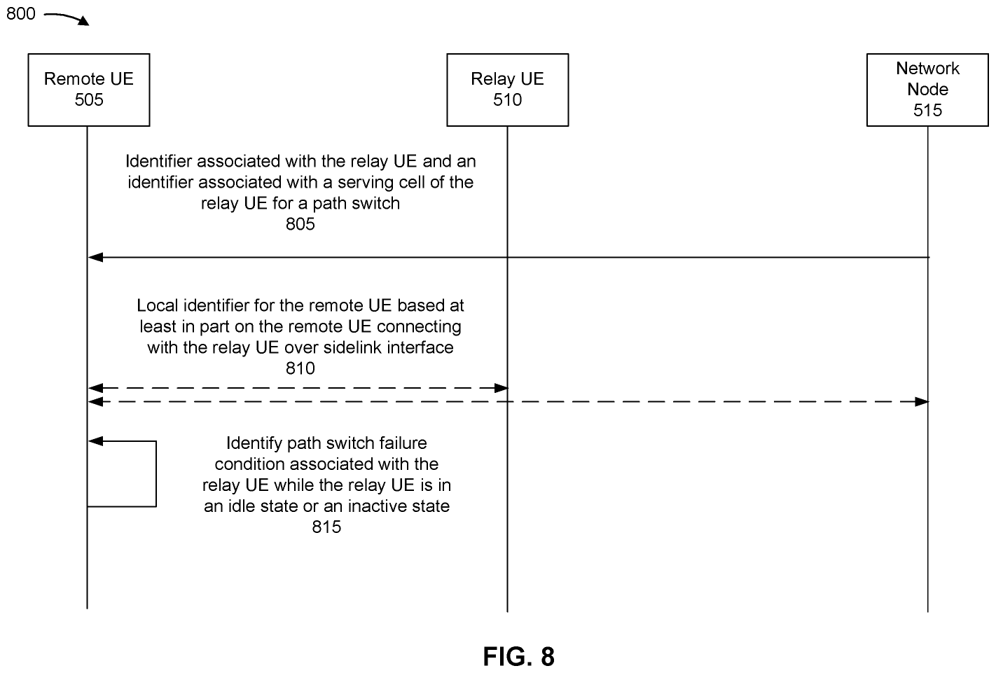

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-13).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-13).

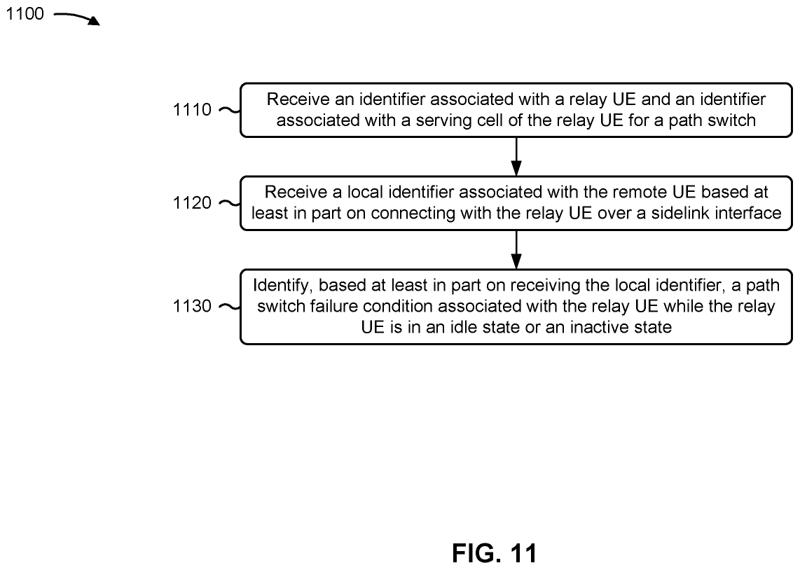

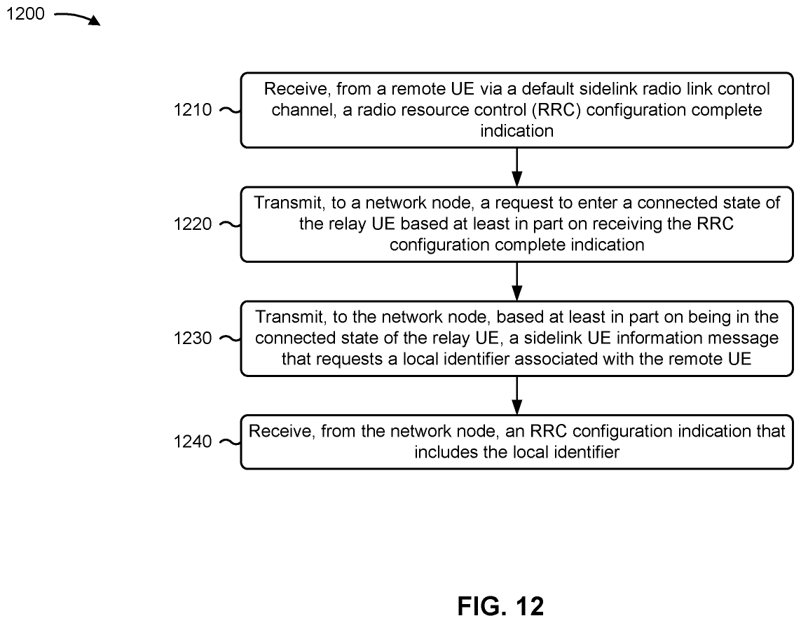

The controller/processor 240 of the base station 110, the controller/processor 280 of the UE 120, and/or any other component(s) of FIG. 2 may perform one or more techniques associated with path switch failure handling, as described in more detail elsewhere herein. For example, the controller/processor 240 of the base station 110, the controller/processor 280 of the UE 120, and/or any other component(s) of FIG. 2 may perform or direct operations of, for example, process 1100 of FIG. 11, process 1200 of FIG. 12, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 1100 of FIG. 11, process 1200 of FIG. 12, and/or other processes as described herein. In some examples, executing instructions may include running the instructions, converting the instructions, compiling the instructions, and/or interpreting the instructions, among other examples.

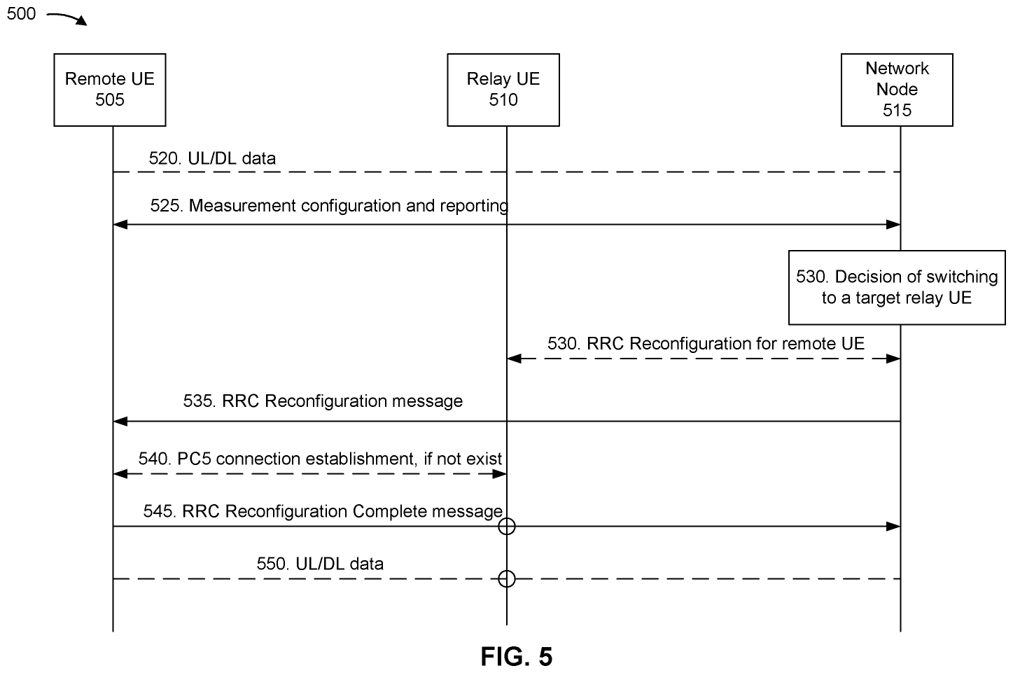

In some aspects, a remote UE (e.g., the remote UE 505 depicted in FIG. 5) includes means for receiving an identifier associated with a relay UE (e.g., the relay UE 510 depicted in FIG. 5) and an identifier associated with a serving cell of the relay UE for a path switch; means for receiving a local identifier associated with the remote UE based at least in part on connecting with the relay UE over a sidelink interface; and/or means for identifying, based at least in part on receiving the local identifier, a path switch failure condition associated with the relay UE while the relay UE is in an idle state or an inactive state. The means for the remote UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a relay UE (e.g., the relay UE 510) includes means for receiving, from a remote UE (e.g., the remote UE 505) via a default sidelink radio link control channel, an RRC configuration complete indication; means for transmitting, to a network node (e.g., the network node 515 depicted in FIG. 5), a request to enter a connected state of the relay UE based at least in part on receiving the RRC configuration complete indication; means for transmitting, to the network node, based at least in part on being in the connected state of the relay UE, a sidelink UE information message that requests a local identifier associated with the remote UE; and/or means for receiving, from the network node, an RRC configuration indication that includes the local identifier. The means for the relay UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

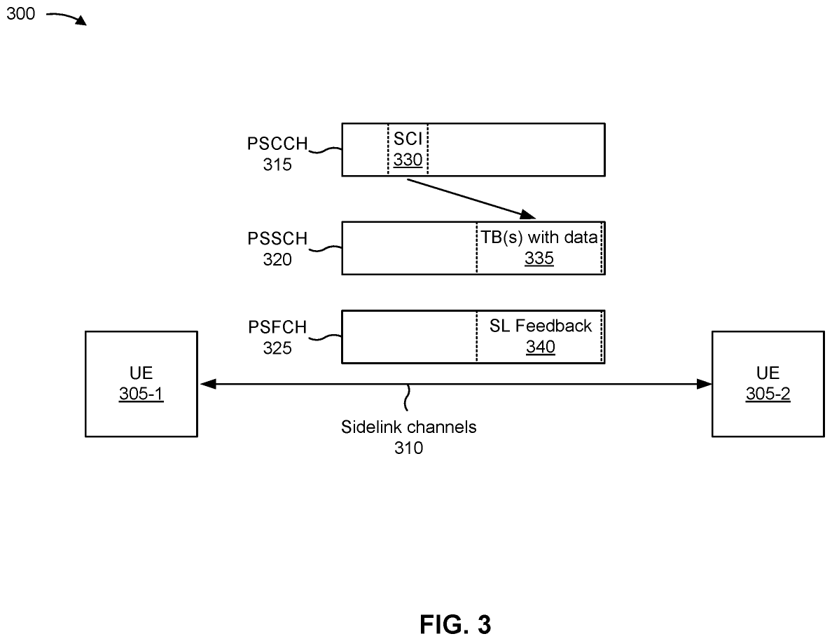

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QoS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in an RRC message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy rate (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As described herein, a remote UE (e.g., the UE 305-1) may identify a path switch failure condition, and may communicate with a relay UE (e.g., the UE 305-2) and/or a network node (e.g., the base station 110) to resolve the path switch failure condition.

As indicated above, FIG. 3 is provided as an example. Other examples may differ from what is described with respect to FIG. 3.

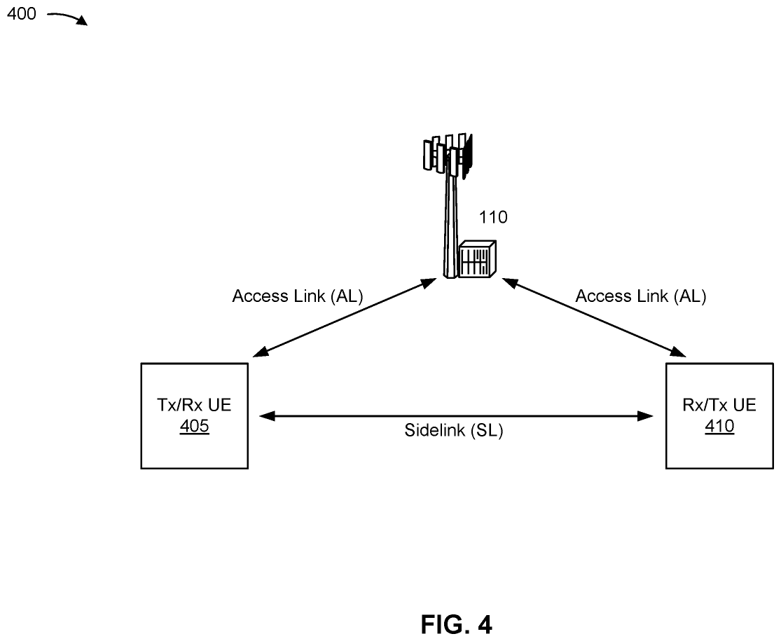

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As described herein, a remote UE (e.g., the UE 405) may identify a path switch failure condition, and may communicate with a relay UE (e.g., the UE 410) and/or a network node (e.g., the base station 110) to resolve the path switch failure condition.

As indicated above, FIG. 4 is provided as an example. Other examples may differ from what is described with respect to FIG. 4.

FIG. 5 is a diagram illustrating an example 500 of a mobility procedure for Layer 2 relays, in accordance with the present disclosure. The remote UE 505, the relay UE 510, and the network node 515 may each communicate with each other. The remote UE 505 and the relay UE 510 may include some or all of the features of the UE 120 described herein. As described herein, the network node 515 may be a base station, such as the base station 110, or may include one or more features of the base station 110.

As shown in connection with reference number 520, the remote UE 505 and the network node 515 may communicate uplink data and/or downlink data. For example, the network node 515 may transmit downlink data to the remote UE 505, and the remote UE 505 may transmit uplink data to the network node 515.

As shown in connection with reference number 525, the remote UE 505 may transmit (e.g., report), and the network node 515 may receive, an indication of one or more candidate relay UEs, such as the relay UE 510. In some aspects, the remote UE 505 may transmit the indication of the one or more relay UEs 510, to the network node 515, based at least in part on the remote UE 505 measuring and/or discovering the one or more candidate relay UEs 510.

As shown in connection with reference number 530, the network node 515 may determine whether or not to switch to the target relay UE 510. Additionally, or alternatively, a target (re)configuration may optionally be sent to the relay UE 510. As shown in connection with reference number 535, the relay UE 510 may transmit an RRC reconfiguration message to the remote UE 505.

As shown in connection with reference number 540, the remote UE 505 may establish a PC5 connection with the relay UE 510, if the connection has not previously been established. As shown in connection with reference number 545, the remote UE 505 may transmit a message (e.g., an RRCReconfigurationComplete message) via the target path, and using the target configuration provided in the RRC reconfiguration message. The message may be received by the network node 515 and/or the relay UE 510.

As shown in connection with reference number 550, data path switching may occur. For example, the remote UE 505, the relay UE 510, and the network node 515 may transmit or receive uplink information or downlink information.

In some aspects, the operations described in connection with reference number 530 may occur after the relay UE 510 connects to the network node 515 (e.g., as described in connection with reference number 540), if the connection has not previously been established.

As indicated above, FIG. 5 is provided as an example. Other examples may differ from what is described with respect to FIG. 5.

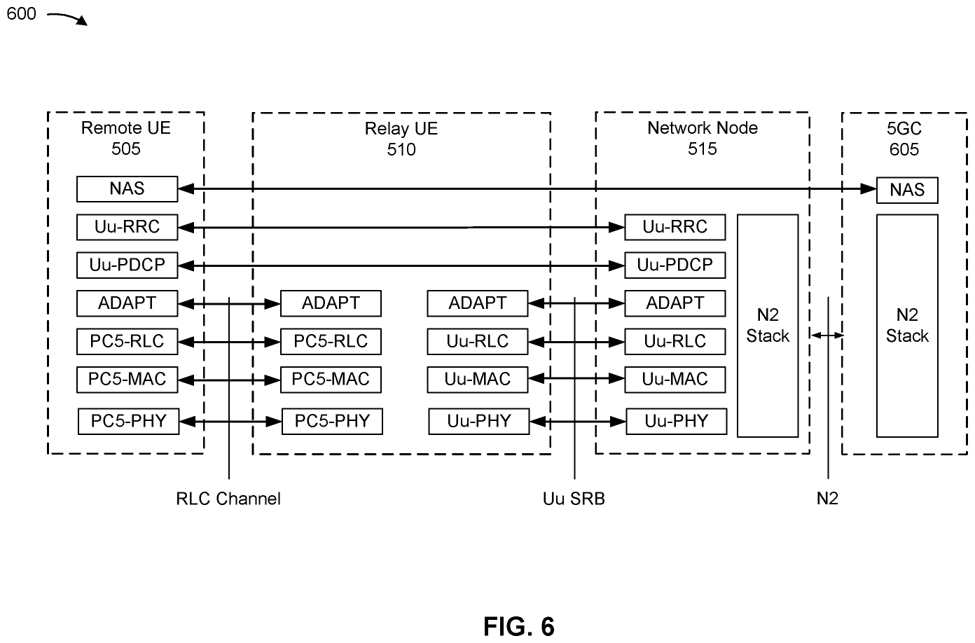

FIG. 6 is a diagram illustrating an example 600 of a protocol stack, in accordance with the present disclosure.

The remote UE 505 and the network node 515 may include respective physical (PHY) layers, medium access control (MAC) layers, radio link control (RLC) layers, adaptation layers (ADAPT), packet data convergence protocol (PDCP) layers, and RRC layers. As shown in the example 600, certain layers may be configured for the sidelink (PC5) interface. For example, the PHY layer, the MAC layer, and the RLC layer of the remote UE 505 may configured for the PC5 interface. Thus, the MAC layer may be shown as a PC5-MAC layer. Alternatively, the PDCP layer and the RRC layer of the remote UE 505 may be configured for the Uu interface. For example, the PDCP layer may be shown as a Uu-PDCP layer. In some cases, the remote UE 505 may include a non-access stratum (NAS) layer for communicating with the core network 605 (e.g., 5GC 605) over the N2 interface. In some cases, the relay UE 510 (e.g., the UE-to-network relay UE 510) may include a subset of the layers described above. For example, the relay UE 510 may include a PHY layer, a MAC layer, an RLC layer, and an ADAPT layer, both for the PC5 interface and the Uu interface. In some cases, the network node 515 and the core network 605 may include an N2 stack for signaling (e.g., control plane signaling) between the network node 515 and the core network 605, such as for UE context management, or PDU session or resource management procedures.

Generally, a first layer is referred to as higher than a second layer if the first layer is further from the PHY layer than the second layer. For example, the PHY layer may be referred to as a lowest layer, and the SDAP/PDCP/RLC/MAC layer may be referred to as higher than the PHY layer and lower than the RRC layer. An application (APP) layer, not shown in FIG. 6, may be higher than the SDAP/PDCP/RLC/MAC layer. In some cases, an entity may handle the services and functions of a given layer (e.g., a PDCP entity may handle the services and functions of the PDCP layer), though the description herein refers to the layers themselves as handling the services and functions.

The RRC layer may handle communications related to configuring and operating the remote UE 505, such as: broadcast of system information related to the access stratum (AS) and the NAS; paging initiated by the 5GC or the NG-RAN; establishment, maintenance, and release of an RRC connection between the UE and the NG-RAN, including addition, modification, and release of carrier aggregation, as well as addition, modification, and release of dual connectivity; security functions including key management; establishment, configuration, maintenance, and release of signaling radio bearers (SRBs) and data radio bearers (DRBs); mobility functions (e.g., handover and context transfer, UE cell selection and reselection and control of cell selection and reselection, inter-RAT mobility); quality of service (QoS) management functions; UE measurement reporting and control of the reporting; detection of and recovery from radio link failure; and NAS message transfer between the NAS layer and the lower layers of the UE 120. The RRC layer is frequently referred to as Layer 3 (L3).

The SDAP layer, PDCP layer, RLC layer, and MAC layer may be collectively referred to as Layer 2 (L2). Thus, in some cases, the SDAP, PDCP, RLC, and MAC layers are referred to as sublayers of Layer 2. On the transmitting side (e.g., if the remote UE 505 is transmitting an uplink communication or the network node 515 is transmitting a downlink communication), the SDAP layer may receive a data flow in the form of a QoS flow. A QoS flow is associated with a QoS identifier, which identifies a QoS parameter associated with the QoS flow, and a QoS flow identifier (QFI), which identifies the QoS flow. Policy and charging parameters are enforced at the QoS flow granularity. A QoS flow can include one or more service data flows (SDFs), so long as each SDF of a QoS flow is associated with the same policy and charging parameters. In some aspects, the RRC/NAS layer may generate control information to be transmitted and may map the control information to one or more radio bearers for provision to the PDCP layer.

The SDAP layer, or the RRC/NAS layer, may map QoS flows or control information to radio bearers. Thus, the SDAP layer may be said to handle QoS flows on the transmitting side. The SDAP layer may provide the QoS flows to the PDCP layer via the corresponding radio bearers. The PDCP layer may map radio bearers to RLC channels. The PDCP layer may handle various services and functions on the user plane, including sequence numbering, header compression and decompression (if robust header compression is enabled), transfer of user data, reordering and duplicate detection (if in-order delivery to layers above the PDCP layer is required), PDCP protocol data unit (PDU) routing (in case of split bearers), retransmission of PDCP service data units (SDUs), ciphering and deciphering, PDCP SDU discard (e.g., in accordance with a timer, as described elsewhere herein), PDCP re-establishment and data recovery for RLC acknowledged mode (AM), and duplication of PDCP PDUs. The PDCP layer may handle similar services and functions on the control plane, including sequence numbering, ciphering, deciphering, integrity protection, transfer of control plane data, duplicate detection, and duplication of PDCP PDUs.

The PDCP layer may provide data, in the form of PDCP PDUs, to the RLC layer via RLC channels. The RLC layer may handle transfer of upper layer PDUs to the MAC and/or PHY layers, sequence numbering independent of PDCP sequence numbering, error correction via automatic repeat requests (ARQ), segmentation and re-segmentation, reassembly of an SDU, RLC SDU discard, and RLC re-establishment.

The ADAPT layer may be used for relaying communications between the PC5 interface of the remote UE 505 and the Uu interface of the network node 515. In some cases, the ADAPT layer may support uplink bearer mapping between ingress PC5 RLC channels and egress Uu RLC channels over the relay UE 505 Uu path. As described herein, the different end-to-end radio bearers (e.g., a signaling radio bearer (SRB) or a data radio bearer (DRB)) of the remote UE 505 and other remote UEs 505 may be subject to N:1 mapping and data multiplexing over a Uu RLC channel. In some cases, the ADAPT layer may support downlink bearer mapping at the network node 515 to map end-to-end radio bearers (e.g., an SRB or a DRB) of the remote UE 505 into a Uu RLC channel over the relay UE 505 Uu path. As described herein, the Uu adaptation layer can be used to support downlink N:1 bearer mapping and data multiplexing between multiple end-to-end radio bearers (e.g., SRB, DRB) and a Uu RLC channel over the Uu path of the relay UE 510.

The RLC layer may provide data, mapped to logical channels, to the MAC layer. The services and functions of the MAC layer include mapping between logical channels and transport channels (used by the PHY layer as described below), multiplexing/demultiplexing of MAC SDUs belonging to one or different logical channels into/from transport blocks (TBs) delivered to/from the physical layer on transport channels, scheduling information reporting, error correction through hybrid ARQ (HARQ), priority handling between UEs by means of dynamic scheduling, priority handling between logical channels of one UE by means of logical channel prioritization, and padding.

The MAC layer may package data from logical channels into TBs, and may provide the TBs on one or more transport channels to the PHY layer. The PHY layer may handle various operations relating to transmission of a data signal, as described in more detail in connection with FIG. 2. The PHY layer is frequently referred to as Layer 1 (L1).

On the receiving side (e.g., if the remote UE 505 is receiving a downlink communication or the network node 515 is receiving an uplink communication), the operations may be similar to those described for the transmitting side, but reversed. For example, the PHY layer may receive TBs and may provide the TBs on one or more transport channels to the MAC layer. The MAC layer may map the transport channels to logical channels and may provide data to the RLC layer via the logical channels. The RLC layer may map the logical channels to RLC channels and may provide data to the PDCP layer via the RLC channels. The PDCP layer may map the RLC channels to radio bearers and may provide data to the SDAP layer or the RRC/NAS layer via the radio bearers.

Data may be passed between the layers in the form of PDUs and SDUs. An SDU is a unit of data that has been passed from a layer or sublayer to a lower layer. For example, the PDCP layer may receive a PDCP SDU. A given layer may then encapsulate the unit of data into a PDU and may pass the PDU to a lower layer. For example, the PDCP layer may encapsulate the PDCP SDU into a PDCP PDU and may pass the PDCP PDU to the RLC layer. The RLC layer may receive the PDCP PDU as an RLC SDU, may encapsulate the RLC SDU into an RLC PDU, and so on. In effect, the PDU carries the SDU as a payload.

As described in more detail below, the remote UE 505 and/or the relay UE 505 may detect one or more path switch failure conditions, and may perform one or more actions to resolve the path switch failure condition.

As indicated above, FIG. 6 is provided as an example. Other examples may differ from what is described with regard to FIG. 6.

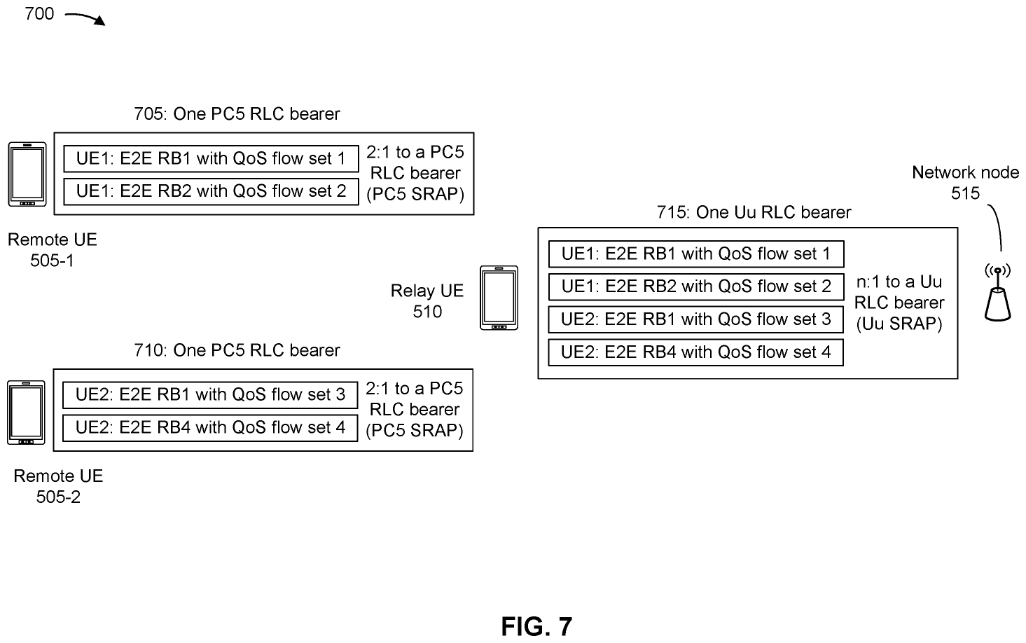

FIG. 7 is a diagram illustrating an example 700 of RLC bearer information, in accordance with the present disclosure. In some cases, a first remote UE 505-1 may have a first PC5 RLC bearer 705 and a second PC5 RLC bearer 710. The first PC5 RLC bearer 705 may include first information that identifies an end-to-end (E2E) radio bearer (RB) 1 with a QoS flow set 1 identifier, and second information that identifies an E2E RB 2 with QoS flow set 2 identifier. The first PC5 RLC bearer 705 may be a 2:1 PC5 RLC bearer (e.g., PC5 sidelink relay adaptation protocol (SRAP)). The second PC5 RLC bearer 710 may include third information that identifies an end-to-end (E2E) radio bearer (RB) 1 with a QoS flow set 3 identifier, and fourth information that identifies an E2E RB 4 with QoS flow set 4 identifier. The second PC5 RLC bearer 710 may be a 2:1 PC5 RLC bearer (e.g., for PC5 SRAP).

In some cases, the relay UE 510 may include a Uu RLC bearer 715. The Uu RLC bearer 715 may include the information from the first PC5 RLC bearer 705 and a second PC5 RLC bearer 710. For example, the Uu RLC bearer 715 may include the first information and the second information, for the first remote UE 505-1, and the third information and the fourth information for the second remote UE 505-2. The Uu RLC bearer 715 may be an n:1 Uu radio bearer (e.g., Uu SRAP). In some cases, the Uu SRAP header may include an E2E bearer ID and a remote UE local ID. The remote UE local ID may be a short ID (e.g., 8-bits) that is assigned by the network node 515 (e.g., for security concerns). In some cases, PC5 SRAP header may include an E2E bearer ID and the remote UE local ID.

In some cases, the relay UE 510 may be indicated as the target relay UE 510, even if the relay UE 510 is in an idle state (e.g., RRC_IDLE) or an inactive state (e.g., RRC_INACTIVE). For example, after receiving a path switch command, the remote UE 505 may establish a PC5 link with the relay UE 510, and may send a handover complete message, via the relay UE 510, which may trigger the relay UE 510 to enter a connected state (e.g., RRC_CONNECTED).

In some cases, the remote UE 505 may include an identifier of the relay UE 510 in a measurement report of the remote UE 505. The identifier of the relay UE 510 may be a Layer 2 identifier that is broadcast in a discovery message. In some cases, the relay UE 510 in the connected state may report the identifier to the network node 515, such that the network node 515 can identify the relay UE 510 via its measurement report.

As described above, the relay UE 510 may be indicated as the target relay UE 510 even if the relay UE 510 is in an idle state or an inactive state. However, this may result in one or more path switch failure conditions. In a first example, the remote UE 505 may not be able to determine the identifier of the relay UE 510 that is indicated in the handover command during the path switch. For example, the relay UE 510 (in the idle or inactive state) may change its L2 identifier and may not notify the network node 515 (since the relay UE 510 is not in a connected state). In a second example, the relay UE 510 may perform a cell reselection. For example, the relay UE 510 may perform the cell reselection during a time gap between the remote UE 505 measurement reporting and path switch execution. In a third example, the relay UE 510 may fail to enter the connected state. For example, the core network may reject the relay UE 510 entering the connected state since the network node 515 has no way to determine if the relay UE 510 is authorized to act as an L2 relay.

Techniques and apparatuses are described herein for path switch failure handling. In some aspects, the remote UE 505 may receive a local identifier for the remote UE 505 based at least in part on connecting with the relay UE 510 over a sidelink (e.g., PC5) interface. The remote UE 505 may identify a path switch failure condition associated with the relay UE 510, after receiving the local identifier, and while the relay UE 510 is in the idle state or the inactive state. The path switch failure condition may include one or more of the conditions described in the first example, the second example, or the third example, in the preceding paragraph. The remote UE 505 and/or the target relay 510 may perform one or more actions to resolve the path switch failure condition.

As described above, the relay UE 510 may be indicated as the target relay UE 510 even if the relay UE 510 is in an idle state or an inactive state. However, this may result in one or more of the path switch failure conditions described in the first example, the second example, or the third example. The remote UE 505 and/or the target relay 510 may perform the one or more actions to resolve the path switch failure condition. Thus, the relay UE 510 may be able to be indicated as the target relay UE, regardless of the current state (e.g., idle, inactive, or connected) of the relay UE 510.

As indicated above, FIG. 7 is provided as an example. Other examples may differ from what is described with regard to FIG. 7.

FIG. 8 is a diagram illustrating an example 800 of path switch failure handling, in accordance with the present disclosure.

As shown in connection with reference number 805, the remote UE 505 may receive an identifier associated with the relay UE 510 and an identifier associated with a serving cell of the relay UE 510 for a path switch. In some aspects, one or more of the identifier associated with the relay UE 510, and the identifier associated with the serving cell of the relay UE 510 for the path switch, may be received by the network node 515.

As shown in connection with reference number 810, the remote UE 505 may receive a local identifier for the remote UE 505 based at least in part on connecting with the relay UE 510 over the sidelink (e.g., PC5) interface. In some aspects, the local identifier for the remote UE 505 may not be included in the path switch command. Instead, the remote UE 505 may only receive the local identifier after the remote UE 505 connects to the relay UE 510 over the PC5 interface. For example, the remote UE 505 may receive the local identifier after connecting with the relay UE 510 that is in the idle state or the inactive state. In some aspects, the local identifier for the remote UE 505 may be an eight bit identifier that is assigned by the network node 515.

As shown in connection with reference number 815, the remote UE 505 may identify a path switch failure condition associated with the relay UE 510. For example, the remote UE 505 may identify the path switch failure condition, after receiving the local identifier, and while the relay UE 510 is in the idle state or the inactive state. The path switch failure condition may correspond to one or more of the example failure conditions indicated above, and described in more detail below.

In the first example, the remote UE 505 may not be able to determine the identifier of the relay UE 510 that is indicated in the handover command during the path switch. For example, the relay UE 510 (in the idle or inactive state) may change its L2 identifier and may not notify the network node 515 (since the relay UE 510 is not in a connected state). In this case, the remote UE 505 may perform one or more of the following:

In some aspects, the remote UE 505 may regard (e.g., identify) the path switch failure, and may trigger an RRC re-establishment.

In some aspects, the remote UE 505 may initiate a timer (e.g., a T304 timer). The remote UE 505 may not initiate the path switch. The remote UE 505 may notify the network node 515 (e.g., the source network node) about the path switch failure condition. The remote UE 505 may initiate an RRC re-establishment procedure based at least in part on an expiration of the timer (e.g., after an expiration of the timer).

In some aspects, the remote UE 505 may be able to track an updated identifier (e.g., the L2 identifier) of the relay UE 510. For example, the remote UE 505 may track the updated L2 identifier of the relay UE 510 based at least in part on monitoring an L2 identifier change by the relay UE 510 in a discovery message. In some aspects, if the remote UE 505 determines that the relay UE 510 does not initiate a cell reselection (e.g., based at least in part on monitoring the discovery message), the remote UE 505 may initiate a path switch using the updated identifier of the relay UE 510. In some aspects, if the remote UE 505 determines that the relay UE 510 does initiate the cell reselection (e.g., based at least in part on monitoring the discovery message), the remote UE 505 may perform one or more of the processes described below in connection with the second example. In some aspects, the remote UE 505 may monitor for the updated L2 identifier of the relay UE 510 using an interval that is based at least in part on one or more discovery cycles.

In the second example, the relay UE 510 may perform a cell reselection. For example, the relay UE 510 may perform the cell reselection during a time gap between the remote UE 505 measurement reporting and path switch execution. In this case, the remote UE 505 may perform one or more of the following:

In some aspects, the remote UE 505 may regard (e.g., identify) the path switch failure, and may trigger an RRC re-establishment.

In some aspects, the remote UE 505 may initiate a timer (e.g., a T304 timer). The remote UE 505 may not initiate the path switch. The remote UE 505 may notify the network node 515 (e.g., the source network node) about the path switch failure condition. The remote UE 505 may initiate an RRC re-establishment procedure based at least in part on an expiration of the timer (e.g., after an expiration of the timer).

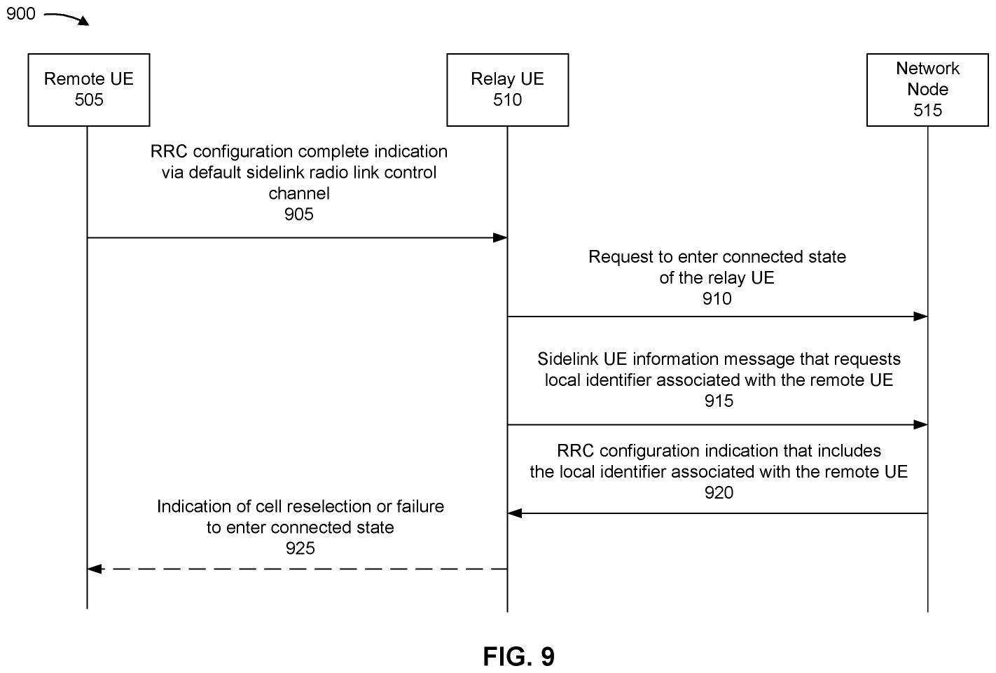

In some aspects, the remote UE 505 may initiate the path switch. For example, the remote UE 505 may establish a unicast PC5 RRC link with the relay UE 510, and may send a reconfiguration complete message (e.g., ReconfigurationComplete) to the relay UE 510. The reconfiguration complete message may include an identifier of the target cell (e.g., an identifier of the network node 515). In this case, the relay UE 510 may perform one or more actions to complete the path switch, as described below in connection with reference number 925 depicted in FIG. 9.

In the third example, the relay UE 510 may fail to enter the connected state. For example, the core network may reject the relay UE 510 entering the connected state since the network node 515 has no way to determine if the relay UE 510 is authorized to act as an L2 relay.

In some aspects, when the relay UE 510 (in the idle or inactive state) fails to enter the connected state, the relay UE 510 may notify the remote UE 505 about the failure to enter the connected state via a PC5 RRC message. The remote UE 505, based at least in part on receiving the indication that the relay UE 510 has failed to enter the connected state, may trigger an RRC re-establishment. In some aspects, the failure to enter the connected state may result from the network node 515 not being able to authorize the relay UE 510. For example, the network node 515 may not have any context for the relay UE 510 while the relay UE 510 is in an idle state. Further, in order for the relay UE 510 to be in the connected state, the core network may need to track whether the relay UE 50 is authorized in the new registration area, and may need to de-register the relay UE 510. In some aspects, the indication of the registration area may be included in a tracking area update (TAU) response, from the core network to the network node 515, to indicate whether the relay UE 510 can be authorized in the new registration area.

As described above, the relay UE 510 may be indicated as the target relay UE 510 even if the relay UE 510 is in an idle state or an inactive state. However, this may result in one or more of the path switch failure conditions described in the first example, the second example, or the third example. The remote UE 505 and/or the target relay 510 may perform the one or more actions to resolve the path switch failure condition. Thus, the relay UE 510 may be able to be indicated as the target relay UE, regardless of the current state (e.g., idle, inactive, or connected) of the relay UE 510.

As indicated above, FIG. 8 is provided as an example. Other examples may differ from what is described with regard to FIG. 8.

FIG. 9 is a diagram illustrating an example 900 of path switch failure handling, in accordance with the present disclosure.

As shown in connection with reference number 905, the remote UE 505 may transmit, and the relay UE 510 may receive, an RRC configuration complete indication. In some aspects, the RRC configuration complete indication may be received via a default sidelink radio link control channel.

As shown in connection with reference number 910, the relay UE 510 may transmit, and the network node 515 may receive, a request for the relay UE 510 to enter a connected state (e.g., RRC_CONNECTED) of the relay UE 510.

As shown in connection with reference number 915, the relay UE 510 may transmit, and the network node 515 may receive, a sidelink UE information message (e.g., a Uu RRC SidelinkUEfnformationNR message) that requests the local identifier for the remote UE 505.

As shown in connection with reference number 920, the network node 515 may transmit, and the relay UE 510 may receive, an RRC configuration indication that includes the local identifier associated with the remote UE 505. In some aspects, the RRC configuration indication may be transmitted via the default PC5 RLC channel. In some aspects, the remote UE 505 local identifier may be included in the PC5 SRAP header of the RRC configuration indication. For example, the remote UE 505 local identifier may be fixed and/or standardized (e.g., 00000000). In some aspects, the PC5 SRAP header may be absent in the RRC configuration indication.

As shown in connection with reference number 925, the relay UE 510 may transmit, and the remote UE 505 may receive, an indication of a cell reselection, or an indication of a failure to enter the connected state.

In some aspects, as described above in connection with reference number 815, in the second example for the path switch failure condition, the remote UE 505 may execute a path switch. For example, the remote UE 505 may establish a unicast PC5 RRC link with the relay UE 510, and may transmit a reconfiguration complete message (e.g., ReconfigurationComplete) to the relay UE 510. The reconfiguration completion message may include an identifier of the network node 515. In this case, the relay UE 510 may perform one or more actions to complete the path switch. For example, the relay UE 510 may initiate a cell reselection, and may transmit a request to the network node 515 (indicated in the reconfiguration complete message) for the relay UE 510 to enter the connected state. Additionally, or alternatively, the relay UE 510 may transmit a request to enter the connected state in the camping cell of the relay UE 510, and the camping cell may obtain the context of the remote UE 505 from the network node 515 indicated in the path switch command.

In some aspects, as described above in connection with reference number 815, in the third example for the path switch failure condition, when the relay UE 510 (in the idle or inactive state) fails to enter the connected state, the relay UE 510 may notify the remote UE 505 about the failure to enter the connected state via a PC5 RRC message. For example, the relay UE 510 may transmit, and the remote UE 505 may receive, an indication that the relay UE 505 has failed to enter the connected state. The remote UE 505, based at least in part on receiving the indication that the relay UE 510 has failed to enter the connected state, may trigger an RRC re-establishment.

As described above, the relay UE 510 may be indicated as the target relay UE 510 even if the relay UE 510 is in an idle state or an inactive state. However, this may result in one or more path switch failure conditions. The remote UE 505 and/or the target relay 510 may perform one or more actions to resolve the path switch failure condition. Thus, the relay UE 510 may be able to be indicated as the target relay UE, regardless of the current state (e.g., idle, inactive, or connected) of the relay UE 510.

As indicated above, FIG. 9 is provided as an example. Other examples may differ from what is described with regard to FIG. 9.

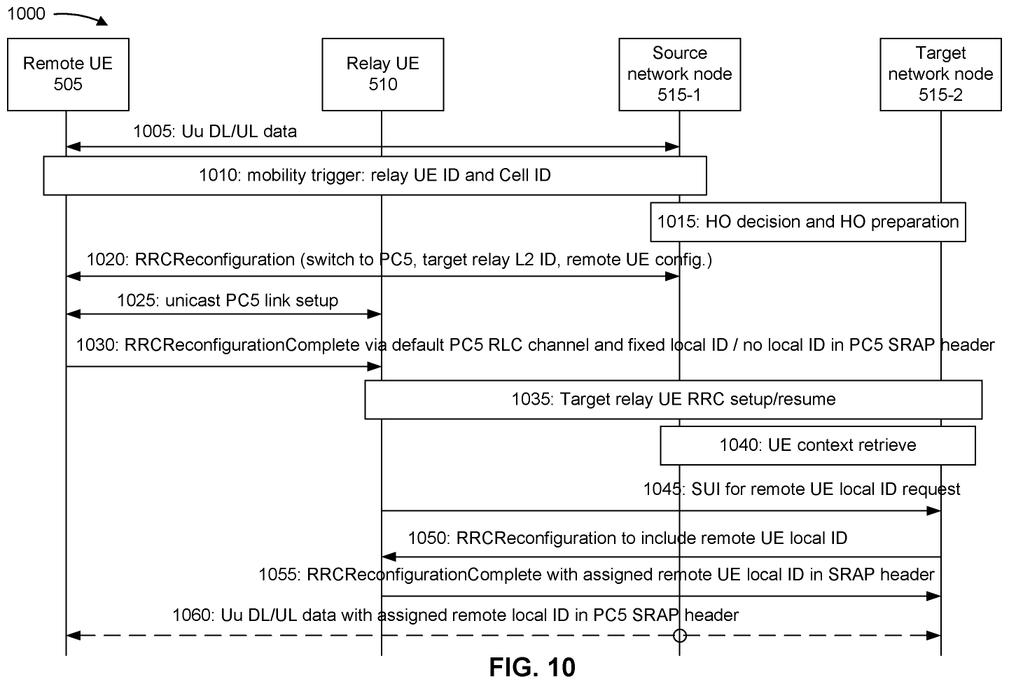

FIG. 10 is a diagram illustrating an example 1000 of remote local identifier assignment in path switch, in accordance with the present disclosure.

As shown in connection with reference number 1005, the remote UE 505 and the source network node 515-1 may communicate downlink and uplink data. For example, the remote UE 505 may transmit uplink data to the source network node 515-1 via the Uu interface, and the source network node 515-1 may transmit downlink data to the remote UE 505 via the Uu interface. In some aspects, the relay UE 510 may be in an inactive state or an idle state.

As shown in connection with reference number 1010, the remote UE 505, the relay UE 510, and/or the source network node 515 may perform a mobility trigger process. For example, the mobility trigger process may be used to determine the relay UE 510 identifier and the cell identifier.

As shown in connection with reference number 1015, the source network node 515-1 and/or the target network node 515-2 may perform handover decision and handover preparation.

As shown in connection with reference number 1020, the remote UE 505 and the source network node 515-1 may communicate RRC reconfiguration information. The RRC reconfiguration information may indicate one or more of a switch to the PC5 interface, the target relay 510 identifier (e.g., the target relay L2 identifier), or the remote UE 505 configuration.

As shown in connection with reference number 1025, the remote UE 505 and the relay UE 510 may communicate regarding a unicast PC5 link setup. For example, the remote UE 505 and the relay UE 510 may establish the PC5 link for sidelink communications.

As shown in connection with reference number 1030, the remote UE 505 may transmit, and the relay UE 510 may receive, an RRC reconfiguration complete message. The RRC reconfiguration complete message may be transmitted via the default PC5 RLC channel. In some aspects, the remote UE 505 local identifier may be included in the PC5 SRAP header. For example, the remote UE 505 local identifier may be fixed and/or standardized (e.g., 00000000). In some aspects, the PC5 SRAP header may be absent in the RRC reconfiguration complete message.

As shown in connection with reference number 1035, the relay UE 510, the source UE 515-1, and/or the target relay 515-2 may perform a target relay UE 510 RRC setup or resume procedure. In some aspects, the relay UE 510 may enter the connected state during the RRC setup or resume procedure, or after the RRC setup or resume procedure.

As shown in connection with reference number 1040, the source network node 515-1 and/or the target network node 515-2 may obtain UE context information. For example, the source network node 515-1 and/or the target network node 515-2 may obtain context information associated with the remote UE 505 and/or the relay UE 510.

As shown in connection with reference number 1045, the relay UE 510 may transmit, and the target network node 515-2 may receive, a request for the remote UE 505 local identifier. For example, the relay UE 510 may transmit, and the target network node 515-2 may receive, an SUI (e.g., a Uu RRC SidelinkUEfnformationNR message) that requests the remote UE 505 local identifier. The relay UE 510 may transmit the request for the UE 505 local identifier after entering the connected state.

As shown in connection with reference number 1050, the target network node 515-2 may transmit, and the relay UE 510 may receive, an indication of the remote UE 505 local identifier. For example, the target network node 515-2 may transmit, and the relay UE 510 may receive, an RRC reconfiguration message that includes the remote UE 505 local identifier.

As shown in connection with reference number 1055, the relay UE 510 may transmit, and the target network node 515-2 may receive, an RRC reconfiguration complete message. The RRC reconfiguration complete message may include the remote UE 505 local identifier in the SRAP header.

As shown in connection with reference number 1060, the target network node 515-2 and the remote UE 505 may communicate Uu downlink and uplink data with the remote UE 505 local identifier in the PC5 SRAP header.

In some aspects, the process described in the example 1000 may be applied to all RRC states (e.g., idle, inactive, and/or connected).

As indicated above, FIG. 10 is provided as an example. Other examples may differ from what is described with regard to FIG. 10.

FIG. 11 is a diagram illustrating an example process 1100 performed, for example, by a remote UE, in accordance with the present disclosure. Example process 1100 is an example where the UE (e.g., UE 120) performs operations associated with path switch failure handling.

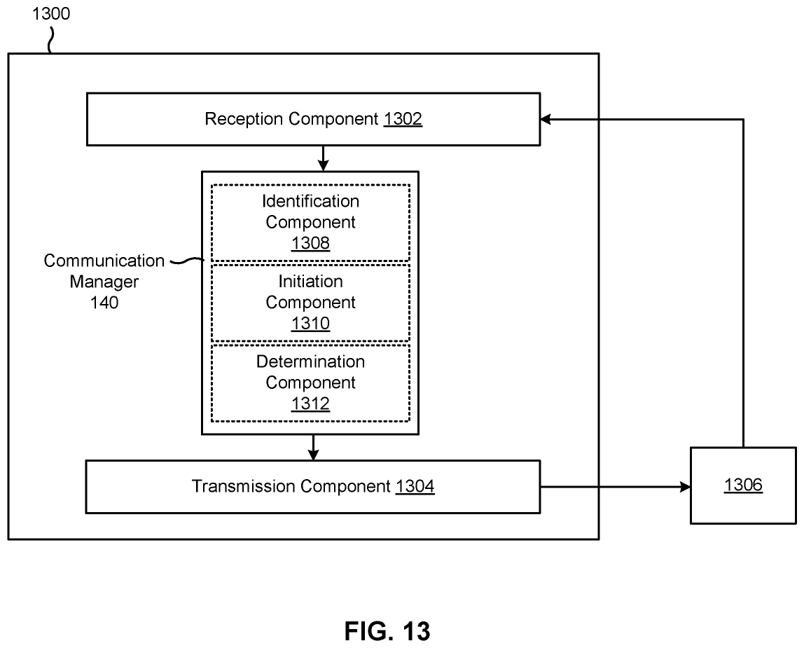

As shown in FIG. 11, in some aspects, process 1100 may include receiving an identifier associated with a relay UE and an identifier associated with a serving cell of the relay UE for a path switch (block 1110). For example, the UE (e.g., using communication manager 140 and/or reception component 1302, depicted in FIG. 13) may receive an identifier associated with a relay UE and an identifier associated with a serving cell of the relay UE for a path switch, as described above.

As further shown in FIG. 11, in some aspects, process 1100 may include receiving a local identifier associated with the remote UE based at least in part on connecting with the relay UE over a sidelink interface (block 1120). For example, the UE (e.g., using communication manager 140 and/or reception component 1302, depicted in FIG. 13) may receive a local identifier associated with the remote UE based at least in part on connecting with the relay UE over a sidelink interface, as described above.

As further shown in FIG. 11, in some aspects, process 1100 may include identifying, based at least in part on receiving the local identifier, a path switch failure condition associated with the relay UE while the relay UE is in an idle state or an inactive state (block 1130). For example, the UE (e.g., using communication manager 140 and/or identification component 1308, depicted in FIG. 13) may identify, based at least in part on receiving the local identifier, a path switch failure condition associated with the relay UE while the relay UE is in an idle state or an inactive state, as described above.

Process 1100 may include additional aspects, such as any single aspect or any combination of aspects described below and/or in connection with one or more other processes described elsewhere herein.

In a first aspect, identifying the path switch failure condition associated with the relay UE comprises determining that an identifier associated with the relay UE in the idle state or the inactive state cannot be identified.

In a second aspect, alone or in combination with the first aspect, process 1100 includes identifying the path switch failure condition, and initiating a radio resource control re-establishment.

In a third aspect, alone or in combination with one or more of the first and second aspects, process 1100 includes initiating a timer, transmitting, to a network node, an indication of the path switch failure condition, and initiating a radio resource control re-establishment based at least in part on an expiration of the timer.

In a fourth aspect, alone or in combination with one or more of the first through third aspects, process 1100 includes determining an updated identifier associated with the relay UE, determining, based at least in part on monitoring a discovery message, that the relay UE has not performed cell reselection, and initiating a path switch using the updated identifier of the relay UE.

In a fifth aspect, alone or in combination with one or more of the first through fourth aspects, process 1100 includes determining an updated identifier associated with the relay UE, determining, based at least in part on monitoring a discovery message, that the relay UE has performed cell reselection, and initiating a radio resource control re-establishment or a path switch.

In a sixth aspect, alone or in combination with one or more of the first through fifth aspects, process 1100 includes receiving an indication of an interval, associated with one or more discovery cycles, for determining an updated identifier associated with the relay UE.

In a seventh aspect, alone or in combination with one or more of the first through sixth aspects, identifying the path switch failure condition associated with the relay UE comprises determining that the relay UE has initiated a cell reselection during a time that is between a measurement reporting and a path switch execution.

In an eighth aspect, alone or in combination with one or more of the first through seventh aspects, process 1100 includes identifying the path switch failure condition, and initiating a radio resource control re-establishment.

In a ninth aspect, alone or in combination with one or more of the first through eighth aspects, process 1100 includes initiating a timer, transmitting, to a network node, an indication of the path switch failure condition, and initiating a radio resource control re-establishment based at least in part on an expiration of the timer.

In a tenth aspect, alone or in combination with one or more of the first through ninth aspects, process 1100 includes initiating a path switch by establishing a unicast sidelink radio resource control link with the relay UE, and transmitting, to the relay UE, an identifier associated with a network node for performing the path switch.

In an eleventh aspect, alone or in combination with one or more of the first through tenth aspects, identifying the path switch failure condition associated with the relay UE comprises determining that the relay UE has failed to enter a connected state.

In a twelfth aspect, alone or in combination with one or more of the first through eleventh aspects, determining that the relay UE has failed to enter the connected state comprises receiving an indication, from the relay UE, that the relay UE has failed to enter the connected state.

In a thirteenth aspect, alone or in combination with one or more of the first through twelfth aspects, process 1100 includes initiating a radio resource control re-establishment based at least in part on receiving the indication that the relay UE has failed to enter the connected state.

In a fourteenth aspect, alone or in combination with one or more of the first through thirteenth aspects, process 1100 includes transmitting, via a default sidelink radio link control channel, an indication of a path switch completion that includes a fixed local identifier in a sidelink adaptation layer header.

In a fifteenth aspect, alone or in combination with one or more of the first through fourteenth aspects, process 1100 includes transmitting, via a default sidelink radio link control channel, an indication of a path switch completion that does not include a sidelink adaptation layer header.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a relay UE, in accordance with the present disclosure. Example process 1200 is an example where the UE (e.g., UE 120) performs operations associated with path switch failure handling.

As shown in FIG. 12, in some aspects, process 1200 may include receiving, from a remote UE via a default sidelink radio link control channel, an RRC configuration complete indication (block 1210). For example, the UE (e.g., using communication manager 140 and/or reception component 1302, depicted in FIG. 13) may receive, from a remote UE via a default sidelink radio link control channel, an RRC configuration complete indication, as described above.

As further shown in FIG. 12, in some aspects, process 1200 may include transmitting, to a network node, a request to enter a connected state of the relay UE based at least in part on receiving the RRC configuration complete indication (block 1220). For example, the UE (e.g., using communication manager 140 and/or transmission component 1304, depicted in FIG. 13) may transmit, to a network node, a request to enter a connected state of the relay UE based at least in part on receiving the RRC configuration complete indication, as described above.

As further shown in FIG. 12, in some aspects, process 1200 may include transmitting, to the network node, based at least in part on being in the connected state of the relay UE, a sidelink UE information message that requests a local identifier associated with the remote UE (block 1230). For example, the UE (e.g., using communication manager 140 and/or transmission component 1304, depicted in FIG. 13) may transmit, to the network node, based at least in part on being in the connected state of the relay UE, a sidelink UE information message that requests a local identifier associated with the remote UE, as described above.

As further shown in FIG. 12, in some aspects, process 1200 may include receiving, from the network node, an RRC configuration indication that includes the local identifier (block 1240). For example, the UE (e.g., using communication manager 140 and/or reception component 1302, depicted in FIG. 13) may receive, from the network node, an RRC configuration indication that includes the local identifier, as described above.

Process 1200 may include additional aspects, such as any single aspect or any combination of aspects described below and/or in connection with one or more other processes described elsewhere herein.

In a first aspect, process 1200 includes transmitting, to the network node, an RRC configuration complete indication that includes the local identifier in an adaptation layer header.

In a second aspect, alone or in combination with the first aspect, process 1200 includes receiving, from the remote UE, an indication of a path switch completion and an identifier associated with a target network node, determining that a camping cell of the relay UE not the target network node, performing a cell reselection to camp in the target network node, and transmitting, to the target network node, an indication of the cell reselection and a request to enter the connected state of the relay UE.

In a third aspect, alone or in combination with one or more of the first and second aspects, process 1200 includes receiving, from the remote UE, an indication of a path switch completion and an identifier associated with a target network node, determining that a camping cell of the relay UE is the target network node, and transmitting, to the camping cell, a request to enter the connected state of the relay UE.

In a fourth aspect, alone or in combination with one or more of the first through third aspects, process 1200 includes transmitting, to the remote UE via a sidelink radio resource control message, an indication of a failure to enter the connected state of the relay UE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. The UE may be the UE 120, the remote UE 505, the relay UE 510, or some combination thereof. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include the communication manager 140. The communication manager 140 may include one or more of an identification component 1308, an initiation component 1310, or a determination component 1312, among other examples.

In some aspects, the apparatus 1300 may be configured to perform one or more operations described herein in connection with FIGS. 8-10. Additionally, or alternatively, the apparatus 1300 may be configured to perform one or more processes described herein, such as process 1100 of FIG. 11, process 1200 of FIG. 12, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the UE described in connection with FIG. 2.

The transmission component 1304 may transmit communications, such as reference signals, control information, data communications, or a combination thereof, to the apparatus 1306. In some aspects, one or more other components of the apparatus 1300 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modem, a modulator, a transmit MIMO processor, a transmit processor, a controller/processor, a memory, or a combination thereof, of the UE described in connection with FIG. 2. In some aspects, the transmission component 1304 may be co-located with the reception component 1302 in a transceiver.

The reception component 1302 may receive an identifier associated with a relay UE and an identifier associated with a serving cell of the relay UE for a path switch. The reception component 1302 may receive a local identifier associated with the remote UE based at least in part on connecting with the relay UE over a sidelink interface. The identification component 1308 may identify, based at least in part on receiving the local identifier, a path switch failure condition associated with the relay UE while the relay UE is in an idle state or an inactive state.

The identification component 1308 may identify the path switch failure condition. The initiation component 1310 may initiate a radio resource control re-establishment.

The initiation component 1310 may initiate a timer. The transmission component 1304 may transmit, to a network node, an indication of the path switch failure condition. The initiation component 1310 may initiate a radio resource control re-establishment based at least in part on an expiration of the timer.

The determination component 1312 may determine an updated identifier associated with the relay UE. The determination component 1312 may determine, based at least in part on monitoring a discovery message, that the relay UE has not performed cell reselection. The initiation component 1310 may initiate a path switch using the updated identifier of the relay UE.

The determination component 1312 may determine an updated identifier associated with the relay UE. The determination component 1312 may determine, based at least in part on monitoring a discovery message, that the relay UE has performed cell reselection. The initiation component 1310 may initiate a radio resource control re-establishment or a path switch.

The reception component 1302 may receive an indication of an interval, associated with one or more discovery cycles, for determining an updated identifier associated with the relay UE.

The identification component 1308 may identify the path switch failure condition. The initiation component 1310 may initiate a radio resource control re-establishment.

The initiation component 1310 may initiate a timer. The transmission component 1304 may transmit, to a network node, an indication of the path switch failure condition. The initiation component 1310 may initiate a radio resource control re-establishment based at least in part on an expiration of the timer.

The initiation component 1310 may initiate a path switch by establishing a unicast sidelink radio resource control link with the relay UE. The transmission component 1304 may transmit, to the relay UE, an identifier associated with a network node for performing the path switch.

The initiation component 1310 may initiate a radio resource control re-establishment based at least in part on receiving the indication that the relay UE has failed to enter the connected state.

The transmission component 1304 may transmit, via a default sidelink radio link control channel, an indication of a path switch completion that includes a fixed local identifier in a sidelink adaptation layer header.

The transmission component 1304 may transmit, via a default sidelink radio link control channel, an indication of a path switch completion that does not include a sidelink adaptation layer header.

The reception component 1302 may receive, from a remote UE via a default sidelink radio link control channel, an RRC configuration complete indication. The transmission component 1304 may transmit, to a network node, a request to enter a connected state of the relay UE based at least in part on receiving the RRC configuration complete indication. The transmission component 1304 may transmit, to the network node, based at least in part on being in the connected state of the relay UE, a sidelink UE information message that requests a local identifier associated with the remote UE. The reception component 1302 may receive, from the network node, an RRC configuration indication that includes the local identifier.

The transmission component 1304 may transmit, to the network node, an RRC configuration complete indication that includes the local identifier in an adaptation layer header.

The reception component 1302 may receive, from the remote UE, an indication of a path switch completion and an identifier associated with a target network node. The determination component 1312 may determine that a camping cell of the relay UE is not the target network node. The initiation component 1310 may perform a cell reselection to camp in the target network node. The transmission component 1304 may transmit, to the target network node, an indication of the cell reselection and a request to enter the connected state of the relay UE.

The reception component 1302 may receive, from the remote UE, an indication of a path switch completion and an identifier associated with a target network node. The determination component 1312 may determine that a camping cell of the relay UE is the target network node. The transmission component 1304 may transmit, to the camping cell, a request to enter the connected state of the relay UE.

The transmission component 1304 may transmit, to the remote UE via a sidelink radio resource control message, an indication of a failure to enter the connected state of the relay UE.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

Aspect 1: A method of wireless communication performed by a remote user equipment (UE), comprising: receiving an identifier associated with a relay UE and an identifier associated with a serving cell of the relay UE for a path switch; receiving a local identifier associated with the remote UE based at least in part on connecting with the relay UE over a sidelink interface; and identifying, based at least in part on receiving the local identifier, a path switch failure condition associated with the relay UE while the relay UE is in an idle state or an inactive state.

Aspect 2: The method of Aspect 1, wherein identifying the path switch failure condition associated with the relay UE comprises: determining that an identifier associated with the relay UE in the idle state or the inactive state cannot be identified.

Aspect 3: The method of Aspect 2, further comprising: identifying the path switch failure condition; and initiating a radio resource control re-establishment.

Aspect 4: The method of Aspect 2, further comprising: initiating a timer; transmitting, to a network node, an indication of the path switch failure condition; and initiating a radio resource control re-establishment based at least in part on an expiration of the timer.

Aspect 5: The method of Aspect 2, further comprising: determining an updated identifier associated with the relay UE; determining, based at least in part on monitoring a discovery message, that the relay UE has not performed cell reselection; and initiating a path switch using the updated identifier of the relay UE.

Aspect 6: The method of Aspect 2, further comprising: determining an updated identifier associated with the relay UE; determining, based at least in part on monitoring a discovery message, that the relay UE has performed cell reselection; and initiating a radio resource control re-establishment or a path switch.

Aspect 7: The method of Aspect 2, further comprising receiving an indication of an interval, associated with one or more discovery cycles, for determining an updated identifier associated with the relay UE.

Aspect 8: The method of any of Aspects 1-7, wherein identifying the path switch failure condition associated with the relay UE comprises: determining that the relay UE has initiated a cell reselection during a time that is between a measurement reporting and a path switch execution.

Aspect 9: The method of Aspect 8, further comprising: identifying the path switch failure condition; and initiating a radio resource control re-establishment.

Aspect 10: The method of Aspect 8, further comprising: initiating a timer; transmitting, to a network node, an indication of the path switch failure condition; and initiating a radio resource control re-establishment based at least in part on an expiration of the timer.

Aspect 11: The method of Aspect 8, further comprising: initiating a path switch by establishing a unicast sidelink radio resource control link with the relay UE; and transmitting, to the relay UE, an identifier associated with a network node for performing the path switch.

Aspect 12: The method of any of Aspects 1-11, wherein identifying the path switch failure condition associated with the relay UE comprises: determining that the relay UE has failed to enter a connected state.

Aspect 13: The method of Aspect 12, wherein determining that the relay UE has failed to enter the connected state comprises receiving an indication, from the relay UE, that the relay UE has failed to enter the connected state.

Aspect 14: The method of Aspect 13, further comprising initiating a radio resource control re-establishment based at least in part on receiving the indication that the relay UE has failed to enter the connected state.

Aspect 15: The method of any of Aspects 1-14, further comprising transmitting, via a default sidelink radio link control channel, an indication of a path switch completion that includes a fixed local identifier in a sidelink adaptation layer header.

Aspect 16: The method of any of Aspects 1-15, further comprising transmitting, via a default sidelink radio link control channel, an indication of a path switch completion that does not include a sidelink adaptation layer header.

Aspect 17: A method of wireless communication performed by a relay user equipment (UE), comprising: receiving, from a remote UE via a default sidelink radio link control channel, a radio resource control (RRC) configuration complete indication; transmitting, to a network node, a request to enter a connected state of the relay UE based at least in part on receiving the RRC configuration complete indication; transmitting, to the network node, based at least in part on being in the connected state of the relay UE, a sidelink UE information message that requests a local identifier associated with the remote UE; and receiving, from the network node, an RRC configuration indication that includes the local identifier.

Aspect 18: The method of Aspect 17, further comprising transmitting, to the network node, an RRC configuration complete indication that includes the local identifier in an adaptation layer header.

Aspect 19: The method of any of Aspects 17-18, further comprising: receiving, from the remote UE, an indication of a path switch completion and an identifier associated with a target network node; determining that a camping cell of the relay UE not the target network node; performing a cell reselection to camp in the target network node; and transmitting, to the target network node, an indication of the cell reselection and a request to enter the connected state of the relay UE.

Aspect 20: The method of any of Aspects 17-19, further comprising: receiving, from the remote UE, an indication of a path switch completion and an identifier associated with a target network node; determining that a camping cell of the relay UE is the target network node; and transmitting, to the camping cell, a request to enter the connected state of the relay UE.

Aspect 21: The method of any of Aspects 17-20, further comprising transmitting, to the remote UE via a sidelink radio resource control message, an indication of a failure to enter the connected state of the relay UE.

Aspect 22: An apparatus for wireless communication at a device, comprising a processor; memory coupled with the processor; and instructions stored in the memory and executable by the processor to cause the apparatus to perform the method of one or more of Aspects 1-16.

Aspect 23: A device for wireless communication, comprising a memory and one or more processors coupled to the memory, the one or more processors configured to perform the method of one or more of Aspects 1-16.

Aspect 24: An apparatus for wireless communication, comprising at least one means for performing the method of one or more of Aspects 1-16.

Aspect 25: A non-transitory computer-readable medium storing code for wireless communication, the code comprising instructions executable by a processor to perform the method of one or more of Aspects 1-16.

Aspect 26: A non-transitory computer-readable medium storing a set of instructions for wireless communication, the set of instructions comprising one or more instructions that, when executed by one or more processors of a device, cause the device to perform the method of one or more of Aspects 1-16.

Aspect 27: An apparatus for wireless communication at a device, comprising a processor; memory coupled with the processor; and instructions stored in the memory and executable by the processor to cause the apparatus to perform the method of one or more of Aspects 17-21.

Aspect 28: A device for wireless communication, comprising a memory and one or more processors coupled to the memory, the one or more processors configured to perform the method of one or more of Aspects 17-21.

Aspect 29: An apparatus for wireless communication, comprising at least one means for performing the method of one or more of Aspects 17-21.

Aspect 30: A non-transitory computer-readable medium storing code for wireless communication, the code comprising instructions executable by a processor to perform the method of one or more of Aspects 17-21.

Aspect 31: A non-transitory computer-readable medium storing a set of instructions for wireless communication, the set of instructions comprising one or more instructions that, when executed by one or more processors of a device, cause the device to perform the method of one or more of Aspects 17-21.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus for wireless communication at a remote user equipment (UE), comprising:
one or more memories; and
one or more processors, coupled to the one or more memories, configured to:
receive an identifier associated with a relay UE and an identifier associated with a serving cell of the relay UE for a path switch;
receive a local identifier associated with the remote UE based at least in part on connecting with the relay UE over a sidelink interface; and
identify, based at least in part on receiving the local identifier, a path switch failure condition associated with the relay UE while the relay UE is in an idle state or an inactive state.

2. The apparatus of claim 1, wherein the one or more processors, to identify the path switch failure condition associated with the relay UE, are configured to:
determine that an identifier associated with the relay UE in the idle state or the inactive state cannot be identified.

3. The apparatus of claim 2, wherein the one or more processors are further configured to:
identify the path switch failure condition; and
initiate a radio resource control re-establishment.

4. The apparatus of claim 2, wherein the one or more processors are further configured to:
initiate a timer;
transmit, to a network node, an indication of the path switch failure condition; and
initiate a radio resource control re-establishment based at least in part on an expiration of the timer.

5. The apparatus of claim 2, wherein the one or more processors are further configured to:
determine an updated identifier associated with the relay UE;
determine, based at least in part on monitoring a discovery message, that the relay UE has not performed cell reselection; and
initiate a path switch using the updated identifier of the relay UE.

6. The apparatus of claim 2, wherein the one or more processors are further configured to:
determine an updated identifier associated with the relay UE;
determine, based at least in part on monitoring a discovery message, that the relay UE has performed cell reselection; and
initiate a radio resource control re-establishment or a path switch.

7. The apparatus of claim 2, wherein the one or more processors are further configured to receive an indication of an interval, associated with one or more discovery cycles, for determining an updated identifier associated with the relay UE.

8. The apparatus of claim 1, wherein the one or more processors, to identify the path switch failure condition associated with the relay UE, are configured to:
determine that the relay UE has initiated a cell reselection during a time that is between a measurement reporting and a path switch execution.

9. The apparatus of claim 8, wherein the one or more processors are further configured to:
identify the path switch failure condition; and
initiate a radio resource control re-establishment.

10. The apparatus of claim 8, wherein the one or more processors are further configured to:
initiate a timer;
transmit, to a network node, an indication of the path switch failure condition; and
initiate a radio resource control re-establishment based at least in part on an expiration of the timer.

11. The apparatus of claim 8, wherein the one or more processors are further configured to:
initiate a path switch by establishing a unicast sidelink radio resource control link with the relay UE; and
transmit, to the relay UE, an identifier associated with a network node for performing the path switch.

12. The apparatus of claim 1, wherein the one or more processors, to identify the path switch failure condition associated with the relay UE, are configured to:
determine that the relay UE has failed to enter a connected state.

13. The apparatus of claim 12, wherein the one or more processors, to determine that the relay UE has failed to enter the connected state, are configured to receive an indication, from the relay UE, that the relay UE has failed to enter the connected state.

14. The apparatus of claim 13, wherein the one or more processors are further configured to initiate a radio resource control re-establishment based at least in part on receiving the indication that the relay UE has failed to enter the connected state.

15. The apparatus of claim 1, wherein the one or more processors are further configured to transmit, via a default sidelink radio link control channel, an indication of a path switch completion that includes a fixed local identifier in a sidelink adaptation layer header.

16. The apparatus of claim 1, wherein the one or more processors are further configured to transmit, via a default sidelink radio link control channel, an indication of a path switch completion that does not include a sidelink adaptation layer header.

17. An apparatus for wireless communication at a relay user equipment (UE), comprising:
one or more memories; and
one or more processors, coupled to the one or more memories, configured to:
receive, from a remote UE via a default sidelink radio link control channel, a radio resource control (RRC) configuration complete indication;
transmit, to a network node, a request to enter a connected state of the relay UE based at least in part on receiving the RRC configuration complete indication;
transmit, to the network node, based at least in part on being in the connected state of the relay UE, a sidelink UE information message that requests a local identifier associated with the remote UE; and
receive, from the network node, an RRC configuration indication that includes the local identifier.

18. The apparatus of claim 17, wherein the one or more processors are further configured to transmit, to the network node, an RRC configuration complete indication that includes the local identifier in an adaptation layer header.

19. The apparatus of claim 17, wherein the one or more processors are further configured to:
receive, from the remote UE, an indication of a path switch completion and an identifier associated with a target network node;
determine that a camping cell of the relay UE not the target network node;
perform a cell reselection to camp in the target network node; and
transmit, to the target network node, an indication of the cell reselection and a request to enter the connected state of the relay UE.

20. The apparatus of claim 17, wherein the one or more processors are further configured to:
receive, from the remote UE, an indication of a path switch completion and an identifier associated with a target network node;
determine that a camping cell of the relay UE is the target network node; and
transmit, to the camping cell, a request to enter the connected state of the relay UE.

21. The apparatus of claim 17, wherein the one or more processors are further configured to transmit, to the remote UE via a sidelink radio resource control message, an indication of a failure to enter the connected state of the relay UE.

22. A method of wireless communication performed by a remote user equipment (UE), comprising:
receiving an identifier associated with a relay UE and an identifier associated with a serving cell of the relay UE for a path switch;
receiving a local identifier associated with the remote UE based at least in part on connecting with the relay UE over a sidelink interface; and
identifying, based at least in part on receiving the local identifier, a path switch failure condition associated with the relay UE while the relay UE is in an idle state or an inactive state.

23. The method of claim 22, wherein identifying the path switch failure condition associated with the relay UE comprises:
determining that an identifier associated with the relay UE in the idle state or the inactive state cannot be identified.

24. The method of claim 23, further comprising:
identifying the path switch failure condition; and
initiating a radio resource control re-establishment.

25. The method of claim 23, further comprising:
initiating a timer;
transmitting, to a network node, an indication of the path switch failure condition; and
initiating a radio resource control re-establishment based at least in part on an expiration of the timer.

26. The method of claim 23, further comprising:
determining an updated identifier associated with the relay UE;
determining, based at least in part on monitoring a discovery message, that the relay UE has not performed cell reselection; and
initiating a path switch using the updated identifier of the relay UE.

27. The method of claim 23, further comprising:
determining an updated identifier associated with the relay UE;
determining, based at least in part on monitoring a discovery message, that the relay UE has performed cell reselection; and
initiating a radio resource control re-establishment or a path switch.

28-32. (canceled)

33. A method of wireless communication performed by a relay user equipment (UE), comprising:
receiving, from a remote UE via a default sidelink radio link control channel, a radio resource control (RRC) configuration complete indication;
transmitting, to a network node, a request to enter a connected state of the relay UE based at least in part on receiving the RRC configuration complete indication;
transmitting, to the network node, based at least in part on being in the connected state of the relay UE, a sidelink UE information message that requests a local identifier associated with the remote UE; and
receiving, from the network node, an RRC configuration indication that includes the local identifier.

34. The method of claim 33, further comprising transmitting, to the network node, an RRC configuration complete indication that includes the local identifier in an adaptation layer header.

35. The method of claim 33, further comprising:
receiving, from the remote UE, an indication of a path switch completion and an identifier associated with a target network node;
determining that a camping cell of the relay UE not the target network node;
performing a cell reselection to camp in the target network node; and
transmitting, to the target network node, an indication of the cell reselection and a request to enter the connected state of the relay UE.
